(19) United States
(12) Patent Application Publication
(10) Pub. No.: US 2010/0067336 A1
(43) Pub. Date: Mar. 18, 2010

(54) DEVICE AND METHOD FOR REPRODUCING INFORMATION AND COMPUTER PROGRAM

(75) Inventors: Kenichi Oono, Tokorozawa-shi (JP); Keiji Katata, Tokorozawa-shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/088,114

(22) PCT Filed: Sep. 21, 2006
(86) PCT No.: PCT/JP2006/318717

§ 371 Date: Sep. 16, 2009

(30) Foreign Application Priority Data
Sep. 27, 2005 (JP) 2005-281001

(51) Int. Cl. G11B 20/00

(52) U.S. Cl. 369/47.15; 369/94; G9B/20

(57) ABSTRACT

An information reproducing device reproduces information in an information recording medium provided with, in addition to a first recording layer readable by a first laser beam, at least one of a second recording layer readable by a second laser beam, and a third recording layer readable by a third laser beam. The information reproducing device includes an optical pickup element applying a laser beam and receiving its reflection; a first judging element first determining whether the first recording layer exists, based on an output from the optical pickup element; a second judging element secondly determining on either of the recording layers is set by a user as a prioritized reproducing layer to be reproduced first; a reproducing element reproducing recorded information; and a control element controlling the reproducing element to reproduce the recorded information, based on outputs from the first judgment element, second judgment, and optical pickup elements.

### TECHNICAL FIELD

The present invention relates to an information reproducing apparatus for and an information reproducing method of performing reproduction on a multilayer hybrid type information recording medium, such as a dual-layer hybrid type optical disc, and a computer program.

### BACKGROUND ART

In an information recording medium, such as optical discs of a CD-ROM (Compact Disc-Read Only Memory), a CD-R (Compact Disc-Recordable), a DVD-ROM, a BD (Blu-ray Disc), and the like, as described in patent documents 1 and 2, etc., there is also developed an information recording medium of a dual-layer type or double layer type, or a multiple layer (multilayer) type, in which a plurality of recording layers are laminated or stacked on the same substrate. More specifically, the dual-layer type optical disc has a first recording layer, as a first layer, located on the front (i.e. on the closer side to an optical pickup) viewed from a laser light irradiation side in the reproduction on an information reproducing apparatus, and it further has a semi-transmissive reflective film located on the rear side (i.e. on the farther side to the optical pickup). The dual-layer type optical disc has a second recording layer, as a second layer, located through an intermediate layer, such as an adhesive layer, on the rear side of the semi-transmissive reflective film, and it has a reflective film located on the rear side thereof. The information reproducing apparatus, such as a DVD player, which performs the reproduction of the dual-layer type optical disc, reproduces information recorded in the first recording layer by focusing laser light for reproduction on the first recording layer, and reproduces information recorded in the second recording layer by focusing the laser light on the second recording layer.

Moreover, a patent document 3 or the like discloses a method of reproducing record information recorded on a hybrid type information recording medium, such as a hybrid disc provided with a Blu-ray disc. Here, the “hybrid type information recording medium” means an information recording medium with a plurality of recording layers in each of which the reproduction can be performed by respective one of a plurality of laser light with corresponding different wavelengths.

Patent document 1: Japanese Patent Application Laid Open NO. 2000-311346
Patent document 2: Japanese Patent Application Laid Open NO. 2001-23237
Patent document 3: Japanese Patent Application Laid Open NO. Hei 11-86338

### DISCLOSURE OF INVENTION

### Subject to be Solved by the Invention

However, the method of reproducing the record information recorded on the hybrid type information recording medium, disclosed in the patent document 3 or the like, causes the following technical problem. That is, the reproducing method for the hybrid type information recording medium, disclosed in the patent document 3 or the like, needs reproduction setting redundantly twice if a predetermined recording layer in which identification information is recorded is not a preferential reproduction layer in which it is set by a user to preferentially perform the reproduction; namely, the reproduction setting including the setting of various physical and logical parameters in the laser light corresponding to the predetermined recording layer and the reproduction setting including the setting of various physical and logical parameters in the laser light corresponding to the preferential reproduction layer. In addition, it is also necessary to perform a process of reading the identification information recorded in the predetermined recording layer. Thus, there is such a technical problem that it is hard to realize a reduction in time required to start the reproduction of the record information recorded in the preferential reproduction layer desired by the user, only by the amount of time required for the redundant processes, which are (i) a process of the reproduction setting to irradiate the predetermined laser light and (ii) a process of reading the identification information by using the predetermined laser light.

It is therefore an object of the present invention to provide an information reproducing apparatus and method, and a computer program, which enable the record information to be reproduced, more quickly and accurately, on a multilayer hybrid type information recording medium, such as a dual-layer hybrid type optical disc.

### Means for Solving the Subject

(Information Reproducing Apparatus)

Hereinafter, the information reproducing apparatus of the present invention will be explained.

The above object of the present invention can be achieved by an information reproducing apparatus for performing reproduction on an information recording medium provided with at least one recording layer of (ii-1) a second recording layer (DVD) with a signal surface on which reading can be performed by second laser light with a second wavelength and (ii-2) a third recording layer (CD) with a signal surface on which reading can be performed by third laser light with a third wavelength, in addition to (i) a first recording layer with a signal surface on which reading can be performed by first laser light with a first wavelength, the information reproducing apparatus provided with: an optical pickup device for irradiating the first laser light, the second laser light, or the third laser light and receiving reflected light thereof; a first judging device for performing first judgment on whether or not there is the first recording layer, on the basis of an output of the optical pickup device; a second judging device for performing second judgment on whether or not one of the first recording layer, the second recording layer, and the third recording layer is set by a user as a preferential reproduction layer in which the reproduction is preferentially performed; a reproducing device for reproducing record information recorded in the first recording layer, the second recording layer, or the third recording layer; and a controlling device for controlling the reproducing device to reproduce the record information on the basis of the first judgment, the second judgment, and the output of the optical pickup device.

According to the information reproducing apparatus of the present invention, the record information is reproduced in the following process, wherein the record information is recorded on the hybrid type information recording medium, such as a hybrid disc, provided with the plurality of recording layers in each of which the reproduction can be performed by respective one of the plurality of laser light with the corresponding different wavelengths.

Firstly, the first judging device judges whether or not there is the first recoding layer, on the basis of the irradiation of the first laser light by the optical pickup device, such as a blue-ray. Specifically, irradiation setting including the setting of various physical parameters for irradiating the first laser light (hereinafter referred to as “irradiation setting”, as occasion demands), is performed. Then, by irradiating the first recording layer with the first laser light, it is judged whether or not there is the first recoding layer. Here, if it is judged that there is the first recording layer, the information recording medium is highly likely the hybrid type information recording medium provided at least with the first recording layer.

Then, if the preferential reproduction layer set to preferentially perform the reproduction desired by the user is the first recording layer, the irradiation setting is omitted because the irradiation setting, including the setting of various physical parameters for irradiating the first laser light, is already completed. By this, the reproduction of the record information, recorded in the first recording layer, can be quickly started by using the first laser light. On the other hand, if the preferential reproduction layer is not the first recording layer, the reproduction setting is performed, including the setting of various physical and logical parameters for reproducing the record information recorded in the preferential reproduction layer.

As described above, in the reproduction process for the hybrid type information recording medium in the present invention, it is firstly judged whether or not there is the first recording layer corresponding to a Blu-ray, which is a reference recording layer of the hybrid disc, for example. In other words, in the present invention, focus-in (i.e., operation at a focused focal point) is performed, and the first laser light is irradiated with omitting the reproduction setting including the setting of various physical and logical parameters for reproducing the record information recorded in the first recording layer. By this, it is possible to judge whether or not to be the hybrid type information recording medium.

As a result, for example, even if the first recording layer, which is the essential (or reference) recording layer of the hybrid disc, is not the preferential reproduction layer set to preferentially perform the reproduction by the user, it is only necessary to perform the reproduction setting including the setting of various physical and logical parameters in the laser light corresponding to the preferential reproduction layer, only once without redundancy. In other words, it is possible to omit the reproduction setting including the setting of various physical and logical parameters in the laser light corresponding to the first reproduction layer, and it is also possible to omit the process of reading the identification information recorded in the first recording layer.

Consequently, in the reproducing process for the hybrid type information recording medium, it is possible to realize a reduction in the time required to start the reproduction of the record information recorded in the reproduction layer desired by the user, in all the cases, including the case that the first recording layer is not the preferential reproduction layer.

In one aspect of the information reproducing apparatus of the present invention, the first laser light is laser light in substantially blue to substantially bluish-purple, the second laser light is laser light in substantially red, and the third laser light is infrared light.

According to this aspect, the laser light with relatively the shortest wavelength, such as a Blu-ray, can be applied as the first laser light. The laser light with relatively the second shortest wavelength, such as a red-light semiconductor laser, can be applied as the second laser light. The laser light with relatively the longest wavelength, such as infrared light, can be applied as the third laser light.

In another aspect of the information reproducing apparatus of the present invention, the first recording layer is disposed on the closest side, viewed from a laser light irradiation side.

According to this aspect, the aforementioned first judgment can be performed, more quickly, in the recording layer that is firstly irradiated with the laser light, which is an initial operation, for example.

In another aspect of the information reproducing apparatus of the present invention, the first recording layer, the second recording layer, and the third recording layer are disposed in order of the first recording layer, the second recording layer, and the third recording layer, from a laser light irradiation side.

According to this aspect, the aforementioned first judgment can be performed, more quickly, in the recording layer that is firstly irradiated with the laser light, which is an initial operation, for example. In addition, the aforementioned second judgment can be performed, more quickly, in the second recording layer.

In another aspect of the information reproducing apparatus of the present invention, the first judging device further performs third judgment on whether or not there is the second recording layer (e.g., DVD) or the third recording layer (e.g., CD), on the basis of the output of the optical pickup device.

According to this aspect, the first judging device may perform the third judgment on whether or not there is the second recording layer, on the basis of the second laser light for the reproduction of a DVD by the optical pickup device, for example. Alternatively, the first judging device may perform the third judgment on whether or not there is the third recording layer, on the basis of the third laser light for the reproduction of a CD, for example. Therefore, it is possible to perform the third judgment, more quickly and accurately, with regard to whether or not to be the hybrid type information recording medium provided with the first recording layer and the second recording layer, or whether or not to be the hybrid type information recording medium provided with the first recording layer and the third recording layer.

In another aspect of the information reproducing apparatus of the present invention, the first judging device performs the first judgment on the basis of the output of the optical pickup device, the output being performed by receiving the reflected light of the irradiated first laser light.

According to this aspect, the first judging device performs the first judgment on whether or not there is the first recording layer, on the basis of the irradiation and reception of the first laser light for reproducing a BD by the optical pickup device. Therefore, it is possible to judge whether or not to be the information recording medium provided with the first recording layer, more quickly and accurately.

In another aspect of the information reproducing apparatus of the present invention, the information recording medium is provided with a first management area (e.g., DI (Disc Information) area of BD, and BCA) in which identification information can be recorded, the identification information identifying whether or not the information recording medium is a hybrid disc provided with at least one of the second recording layer, and the third recording layer, in addition to the first recording layer and the first judging device performs the first judgment without reading the identification information.

According to this aspect, the first judging device performs the first judgment on whether or not there is the first recoding layer, on the basis of the irradiation and reception of the first laser light for reproducing the BD by the optical pickup device, without reading the identification information recorded in the disc information DI area or a bust cutting area BCA provided for the first recording layer for the BD or the like. Therefore, it is possible to perform the first judgment, more quickly and accurately.

In another aspect of the information reproducing apparatus of the present invention, the first recording layer is provided with a second management area (DI (Disc Information) area of BD) in which the identification information can be recorded, and the first judging device performs the first judgment without reading the identification information.

According to this aspect, the first judging device performs the first judgment on whether or not there is the first recoding layer, on the basis of the irradiation and reception of the first laser light for reproducing the BD by the optical pickup device, without reading the identification information recorded in the disc information DI area provided for the first recording layer for the BD or the like. Therefore, it is possible to perform the first judgment, more quickly and accurately.

In another aspect of the information reproducing apparatus of the present invention, the first judging device performs the first judgment on the basis of whether or not an S-shaped signal, which indicates a focused focal point in the first recording layer (e.g., BD), can be detected at a predetermined depth (e.g., 0.1 mm) (from e.g. surface reflection).

According to this aspect, the first judging device performs the first judgment on the basis of whether or not the S-shaped signal, which indicates the focused focal point of the first recording layer (BD), can be detected at the predetermined depth (e.g., 0.1 mm), which is based on the position at which the surface reflection on the incident plane of the laser light is detected, for example. Therefore, on the basis of the S-shaped signal, the first judgment can be performed, more quickly and accurately.

In another aspect of the information reproducing apparatus of the present invention, the first judging device performs the first judgment on the basis of whether or not return light with a predetermined light intensity, caused by the irradiation of the first laser light, can be obtained at a predetermined depth (e.g., 0.1 mm) (from e.g. surface reflection).

According to this aspect, the first judging device performs the first judgment on the basis of whether or not the return light with the predetermined light intensity, caused by the irradiation of the first laser light, can be obtained at the predetermined depth (e.g., 0.1 mm), which is based on the position at which the surface reflection on the incident plane of the laser light is detected. Therefore, on the basis of the return light, the first judgment can be performed, more quickly and accurately. In addition, substantially in the same manner, it may be judged whether or not there is the second recording layer, on the basis of whether or not the return light with the predetermined light intensity, caused by the irradiation of the second laser light, can be obtained at the predetermined depth. Alternatively, it may be judged whether or not there is the third recording layer, on the basis of whether or not the return light with the predetermined light intensity, caused by the irradiation of the third laser light, can be obtained at the predetermined depth.

In another aspect of the information reproducing apparatus of the present invention, the controlling device further controls the reproducing device to perform reproduction setting (Set Up) for reproducing record information recorded in each of the first recording layer, the second recording layer, and the third recording layer.

According to this aspect, in the reproducing process for the hybrid type information recording medium, it is possible to start the reproduction of the record information after the reproduction setting including the setting of various physical and logical parameters in the laser light.

(Information Reproducing Method)

Hereinafter the information reproducing method of the present invention will be explained.

The above object of the present invention can be also achieved by an information reproducing method in an information reproducing apparatus provided with: an optical pickup device for irradiating an information recording medium with a first laser light (BD), a second laser light (DVD), or a third laser light (CD) and receiving reflected light thereof; and a reproducing device for reproducing record information recorded in the first recording layer, the second recording layer, or the third recording layer, the information recording medium provided with at least one recording layer of (ii-1) the second recording layer with a signal surface on which reading can be performed by second laser light with a second wavelength and (ii-2) the third recording layer with a signal surface on which reading can be performed by third laser light with a third wavelength, in addition to (i) the first recording layer with a signal surface on which reading can be performed by first laser light with a first wavelength, the information reproducing method provided with: a first judging process of performing first judgment on whether or not there is the first recording layer, on the basis of an output of the optical pickup device; a second judging process of performing second judgment on whether or not one of the first recording layer, the second recording layer, and the third recording layer is set by a user as a preferential reproduction layer in which the reproduction is preferentially performed; and a controlling process of controlling the reproducing device to reproduce the record information on the basis of the first judgment, the second judgment, and the output of the optical pickup device.

According to the information reproducing method of the present invention, it is possible to receive various benefits of the aforementioned information reproducing apparatus of the present invention.

In response to the various aspects of the aforementioned information reproducing apparatus of the present invention, the information reproducing method of the present invention can employ various aspects.

(Computer Program)

Hereinafter, the computer program of the present invention will be explained.

The above object of the present invention can be also achieved by a computer program for reproduction control and for controlling a computer provided in the aforementioned information reproducing apparatus of the present invention (including its various aspects), the computer program making the computer function as at least one portion of the optical pickup device, the first judging device, the second judging device, the reproducing device, and the controlling device.

According to the computer program of the present invention, the aforementioned information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned information reproducing apparatus of the present invention, the computer program of the present invention can also employ various aspects.

The above object of the present invention can be also achieved by a computer program product in a computer-readable medium for tangibly embodying a program of instructions executable by a computer provided in the aforementioned information reproducing apparatus of the present invention (including its various aspects), the computer program product making the computer function as at least one portion of the optical pickup device, the first judging device, the second judging device, the reproducing device, and the controlling device.

According to the computer program product of the present invention, the aforementioned information reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information reproducing apparatus of the present invention.

These effects and other advantages of the present invention will become more apparent from the embodiments explained below.

As explained above, according to the information reproducing apparatus of the present invention, it is provided with the optical pickup device, the first judging device, the second judging device, the reproducing device, and the controlling device. According to the information reproducing method of the present invention, it is provided with the first judging process, the second judging process, and the controlling process. As a result, for example, even if the first recording layer, which is the essential (or reference) recording layer of the hybrid disc, is not the preferential reproduction layer set to preferentially perform the reproduction by the user, it is only necessary to perform the reproduction setting including the setting of various physical and logical parameters in the laser light corresponding to the preferential reproduction layer, only once without redundancy. In other words, it is possible to omit the reproduction setting including the setting of various physical and logical parameters in the laser light corresponding to the first reproduction layer, and it is also possible to omit the process of reading the identification information recorded in the first recording layer. Consequently, in the reproducing process for the hybrid type information recording medium, it is possible to realize a reduction in the time required to start the reproduction of the record information recorded in the reproduction layer desired by the user, in all the cases, including the case that the first recording layer is not the preferential reproduction layer.

Moreover, according to the computer program of the present invention, it makes the computer function as the aforementioned information reproducing apparatus of the present invention. Thus, in the reproducing process for the hybrid type information recording medium descried above, it is possible to realize a reduction in the time required to start the reproduction of the record information recorded in the reproduction layer desired by the user, in all the cases, including the case that the first recording layer is not the preferential reproduction layer.

### BRIEF DESCRIPTION OF DRAWINGS

FIG. 1 are a substantial plan view showing the basic structure of an optical disc 100, which is one specific example of the information recording medium in this embodiment (FIG. 1(a)), and a conceptual view showing the optical disc on a section “X”.

FIG. 2 is a more detailed cross sectional view showing the optical disc on the section “X” corresponding to FIG. 1(b).

FIG. 3 is a block diagram schematically showing the basic structure of an information reproducing apparatus for the optical disc in an embodiment of the present invention.

FIG. 4 is a flowchart showing an operation principle of the information reproducing apparatus for the optical disc in the embodiment of the present invention.

FIG. 5 are tables (FIG. 5(a) and FIG. 5(b)) regarding first judgment and second judgment in the operation principle of the information reproducing apparatus for the optical disc in the embodiment of the present invention.

FIG. 6 is a graph showing a relationship between a focus error signal and a travel time of an objective lens, the focus error signal being obtained by the irradiation of laser light by the information reproducing apparatus for the optical disc in the embodiment of the present invention, the objective lens travel time being based on a time at which surface reflection is detected.

FIG. 7 is a detailed cross sectional view showing an optical disc, which is one specific example of the information recording medium in a comparison example.

FIG. 8 is a table showing one specific example of identification information in the comparison example.

FIG. 9 are graphs showing a relationship between a return light intensity and a travel time of an objective lens, the return light intensity being obtained by the irradiation of the laser light by the information reproducing apparatus for the optical disc in the embodiment of the present invention, the objective lens travel time being based on a time at which the return light intensity based on the surface reflection is detected.

FIG. 10 are schematic conceptual views (FIG. 10(a) and FIG. 10(b)) showing optical discs 100a and 100b, which are other specific examples of the information recording medium in the embodiment.

### DESCRIPTION OF REFERENCE CODES

100 optical disc
101 first recording layer
102 second recording layer
103 third recording layer
104a (104b) polycarbonate layer
105a (105b) polycarbonate layer
500 information reproducing apparatus
502 optical pickup
503 spindle motor
504 head amplifier
510 sum generation circuit
511 pit data demodulation circuit
512 pit data correction circuit
520 focus/tracking control signal generation circuit
521 low pass filter
522 servo unit
600 CPU
601 timer
602 memory
LB1 laser light (blue-ray)
LB2 laser light (red-light semiconductor laser)

### BEST MODE FOR CARRYING OUT THE INVENTION

Hereinafter, the best mode for carrying out the present invention will be explained in each embodiment in order with reference to the drawings.

(1) Information Recording Medium in Embodiment

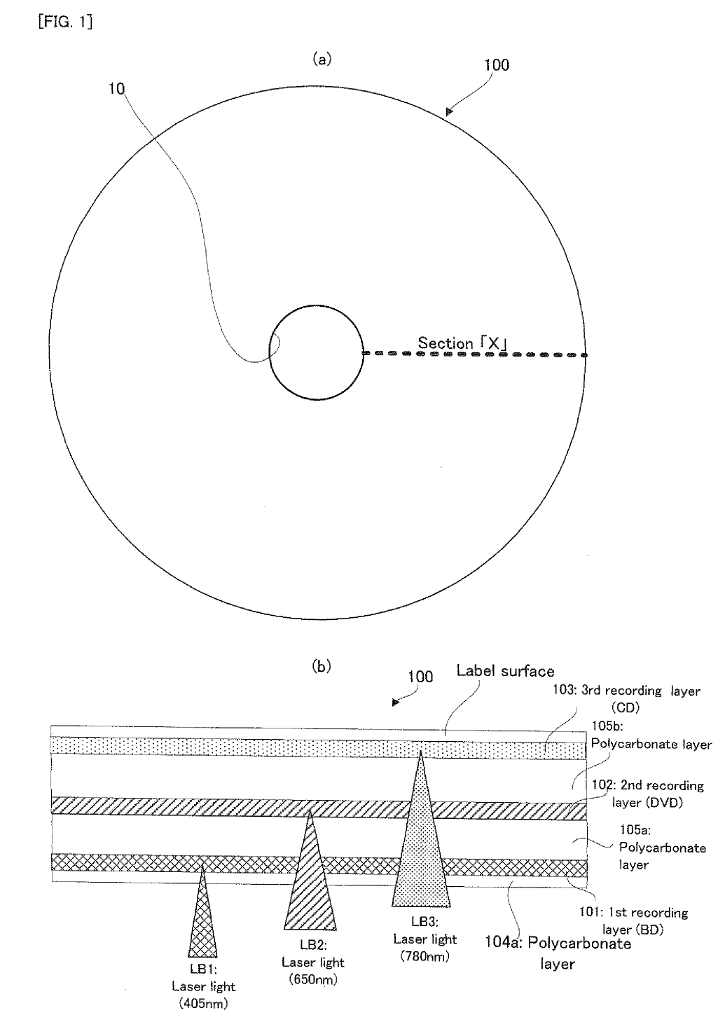

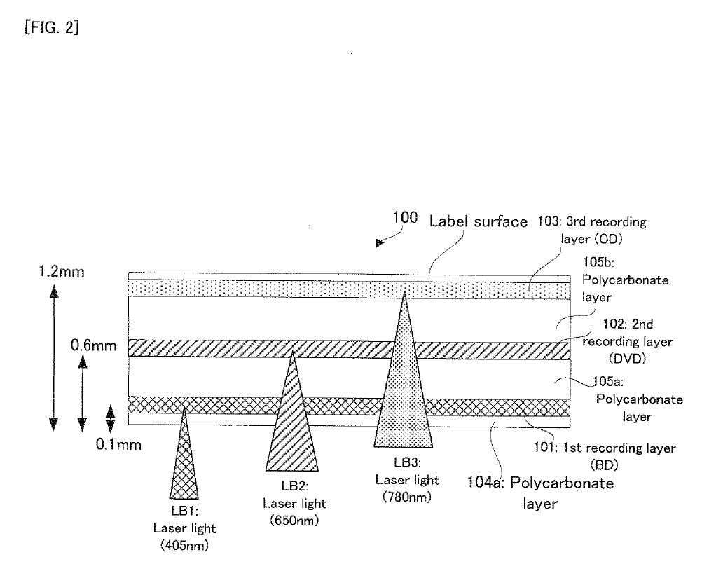

Hereinafter, with reference to FIG. 1 and FIG. 2, one specific example of the information recording medium in the embodiment will be explained.

(1-1) Basic Structure

Firstly, with reference to FIG. 1, a brief explanation will be given on the basic structure of an optical disc, which is one specific example of the information recording medium in this embodiment. FIG. 1(a) is a substantial plan view showing the basic structure of an optical disc 100, which is one specific example of the information recording medium in this embodiment, and FIG. 1(b) is a conceptual view showing the optical disc on a section “X”. FIG. 2 is a more detailed cross sectional view showing the optical disc on the section “X” corresponding to FIG. 1(b).

As shown in FIG. 1(a), the optical disc 100 has a shape of disc with a diameter of about 12 cm and with a center hole 10, as is a DVD. The shape and size, however, are not limited to this, and it is to be understood that various sizes and various shapes may be employed.

As shown in FIG. 1(b), the optical disc 100 is a multilayer hybrid type information recording medium with a plurality of recording layers, such as a three-layer hybrid type disc, in each of which reproduction can be performed by respective one of a plurality of laser light with corresponding different wavelengths.

Specifically, it is provided with: a polycarbonate layer 104a; a first recording layer 101 for BD (Blu-ray Disc); a polycarbonate layer 105a; a second recording layer 102 for DVD or the like; a polycarbonate layer 105b; and a third recording layer 103 for CD or the like.

More specifically, the first recording layer 101 is a recording layer in which a record mark can be reproduced by reflecting laser light LB1, which has a reproduction power, at a predetermined reflectance. Here, the laser light LB1 in the embodiment is laser light with relatively the shortest wavelength, such as a blue-ray with a wavelength of 405 nm. As shown in FIG. 2, specifically, the first recording layer 101 may be disposed at a distance of “0.1 mm” from the incident plane of the laser light, in the polycarbonate layer 104a. Incidentally, the inventors' study has shown that the first recording layer for BD or the like, is preferably located on the front, viewed from the irradiation side of the laser light. That is because optical deterioration, such as coma aberration, is proportional to (i) the thickness of the polycarbonate layer 104a and (ii) the cube of NA (Numerical Aperture), and is inversely proportion to (iii) the wavelength of the laser light. Therefore, with regard to the first recording layer on which the laser light LB with a high NA and a short wavelength is irradiated, the optical deterioration can be reduced by reducing (i) the thickness of the polycarbonate layer 104a. In addition, the first recording layer may be another type of recording layer for HD-DVD (High Density DVD) or the like. Moreover, the first recording layer may have such a property that the reflectance for the laser light with one wavelength is relatively high and that the reflectance for the laser light with another wavelength is relatively low; namely, wavelength selectivity.

The second recording layer 102 is a recording layer in which the record mark can be reproduced by reflecting laser light LB2, which has a reproduction power, at a predetermined reflectance. Here, the laser light LB2 is laser light with relatively the second shortest wavelength, such as red-light laser light with a wavelength of 650 nm. As shown in FIG. 2, specifically, the second recording layer 102 may be disposed at a distance of “0.6 mm” from the incident plane of the laser light, in the polycarbonate layer 104a. Moreover, the second recording layer may have the so-called wavelength selectivity.

The third recording layer 103 is recording layer in which the record mark can be reproduced by reflecting laser light LB3, which has a reproduction power, at a predetermined reflectance. Incidentally, the third recording layer 103 may be constructed so as to laminate a total reflection film which can reflect the laser light LB3. Here, the laser light LB3 in the embodiment is laser light with relatively the longest wavelength, such as infrared light with a wavelength of 708 nm. As shown in FIG. 2, the third recording layer 103 may be disposed at a distance of “1.2 mm” from the incident plane of the laser light, in the polyearbonate layer 104a.

The polycarbonate layer 104a may have, for example, a thickness of 0.1 mm. The polycarbonate layer 104b may have, for example, a thickness of 0.6 mm.

(2) Information Reproducing Apparatus in Embodiment

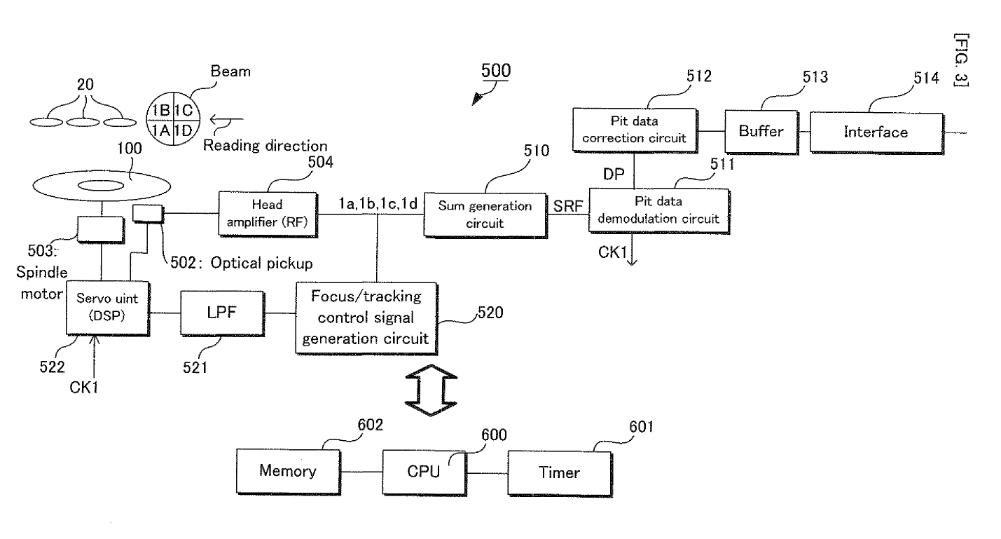

Next, with reference to FIG. 3 to FIG. 6, an information reproducing apparatus for the optical disc in the embodiment of the present invention will be explained.

(2-1) Basic Structure

Firstly, with reference to FIG. 3, an explanation will be given on the basic structure of an information reproducing apparatus for the optical disc in an embodiment of the present invention. FIG. 3 is a block diagram schematically showing the basic structure of the information reproducing apparatus for the optical disc in the embodiment of the present invention.

An information reproducing apparatus 500 is provided with: an optical pickup 502, which constitutes one example of the “reproducing device” and the “optical pickup device” of the present invention; a spindle motor 503; a head amplifier 504; a sum generation circuit 510; a pit data demodulation circuit 511; a pit data correction circuit 512; a buffer 513; an interface 514; a focus/tracking control signal generation circuit 520; a low pass filter 521; a servo unit 522; and a CPU (Central Processing Unit) 600.

On the optical disc 100, pit data DP synchronized with a first clock signal CK1 is recorded in accordance with the length of the record mark. The first clock signal CK1 of a RF reproduction signal component, as explained in various embodiments of the optical disc 100 described above, is a signal which can be generated by the information reproducing apparatus 500 from the RF reproduction signal component of the optical disc 100 which varies at an almost constant frequency. In the embodiment, the first clock signal CK1 is generated by the pit data demodulation circuit 511. Incidentally, in the embodiment, a record mark 20 can be interpreted as a pit, and a track is provided with this pit row.

The information reproducing apparatus 500 is provided, more specifically, with: the optical pickup 502 for irradiating a reproduction beam onto the optical disc 100 and outputting a signal responding to reflected light; the spindle motor 503 for controlling the rotation of the optical disc 100; and the servo unit 522. The servo unit 522 is supplied with the first clock signal CK1. The servo unit 522 is synchronized with these signals, and performs spindle servo for controlling the rotation of the spindle motor 503. Moreover, focus servo and tracking servo for performing relative position control of the optical pickup 502 to the optical disc 100 are performed to position the optical spot on the pit.

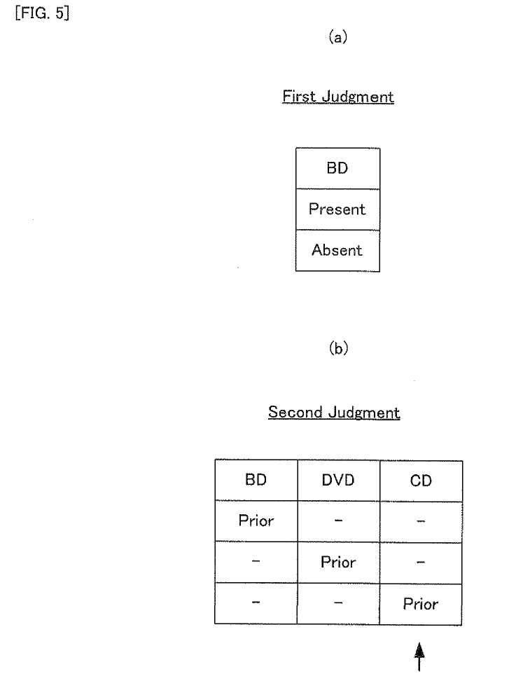

The optical pickup 502 is provided with a laser diode for irradiating the reproduction beam; and a not-illustrated four-division detection circuit. The four-division detection circuit divides the reflected light of the reproduction beam into four areas 1A, 1B, 1C, and 1D shown in the upper part of FIG. 3, and outputs each signal corresponding to the quantity of light in respective one of the areas. The head amplifier 504 amplifies each output signal of the optical pickup 502, and outputs a divisional read signal 1a corresponding to the area 1A, a divisional read signal 1b corresponding to the area 1B, a divisional read signal 1c corresponding to the area 1C, and a divisional read signal 1d corresponding to the area 1D. Incidentally, here, for example, a focus error signal by an astigmatism method is detected (refer to FIG. 5 or the like described later). Moreover, the head amplifier 504 may be embodied by a RF (Radio Frequency) circuit.

The sum generation circuit 510 is provided with an adder circuit for adding the divisional read signals 1a, 1b, 1c, and 1d and outputting a sum read signal SRF. Incidentally, the sum read signal SRF is a signal which represents the length of the record mark. Incidentally, the sum generation circuit 510 or the like may be embodied by a DSP (Digital Signal Processor).

The pit data demodulation circuit 511 reproduces the pit data DP on the basis of the sum read signal SRF, and generates the first clock signal CK1. More specifically, the pit data demodulation circuit 511 demodulates the reproduced pit data DP by using a predetermined table and generates reproduction data, using a pit synchronization signal SYNCp (not illustrated) as a reference position. For example, if EFM modulation is employed as a modulating method, a process of converting 14-bit pit data DP to 8-bit reproduction data is performed. Then, a descramble process is performed in which the order of the reproduction data is rearranged in accordance with a predetermined rule, and the processed reproduction data is outputted.

The reproduction data obtained in this manner is supplied to the pit data correction circuit 512, on which an error correction process and an interpolation process are performed, and then it is stored into the buffer 513. The interface 514 sequentially reads the data stored in the buffer 513, converts it in a predetermined output format, and outputs it to external equipment.

The focus/tracking control signal generation circuit 520 may perform focus control such that a focus control signal in the embodiment uses the astigmatism of a laser diode to calculate (1a+1c)−(1b+1d), which is outputted to the servo unit 522 through the low pass filter 521, and that the value of the outputted signal is zero, Moreover, the focus/tracking control signal generation circuit 520 may perform tracking control such that a tracking control signal in the embodiment uses the diffraction by the pit to calculate a DPD (Differential Phase detect) signal, i.e. (phase comparison between 1a and 1b)+(phase comparison between 1c and 1d), which is outputted to the servo unit 522 through the low pass filter 521, and that the value of the outputted signal is zero. The component 1a and 1d corresponds to the areas 1A and 1D which are on the left side with respect to the reading direction, while the component 1b and 1c corresponds to the areas 1B and 1C which are on the right side with respect to the reading direction. The value of the focus control signal represents a relative positional relationship with a reproduction beam recording layer. Moreover, the value of the tracking control signal represents a relative positional relationship between the reproduction beam and the pit. However aforementioned control method of the focus/tracking control is example.

The CPU 600 is connected through a not-illustrated bus or the like and gives an instruction each circuit or device or the like, to thereby control the information reproducing apparatus 500 as a whole. Normally, software for operating the CPU 600 is stored in a memory 602 or the like. Moreover, the memory 602 provided for the CPU 600 may store information about a result of first judgment and information about a result of second judgment in the present invention, described later. In addition, a timer provided for the CPU 600 may function as a measuring device for measuring a travel time when a travel distance is uniquely derived from the travel time, which is obtained by displacing the objective lens at a constant time.

(2-2) Operation Principle

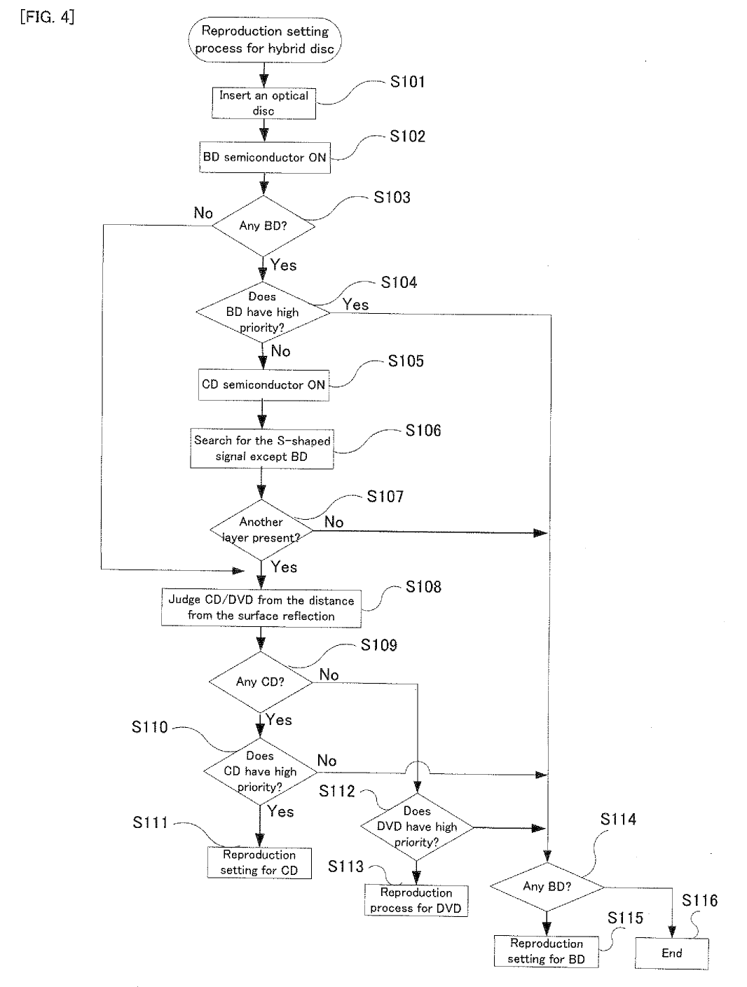

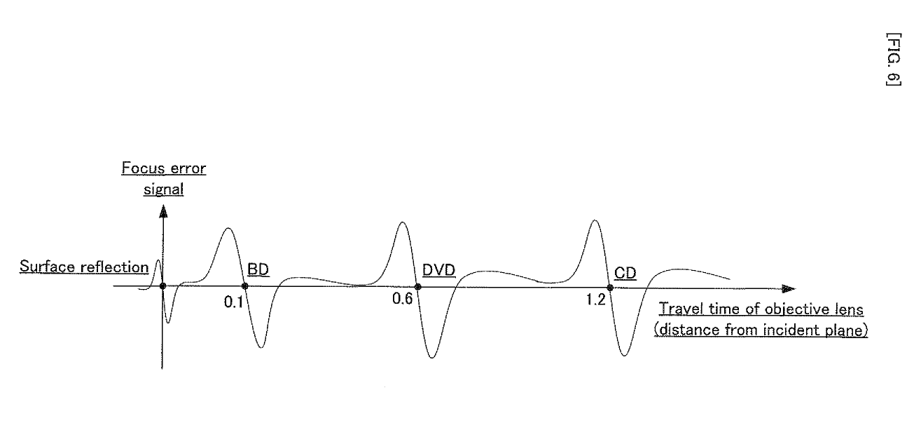

Next, with reference to FIG. 4 and FIG. 6, an explanation will be given on an operation principle of the information reproducing apparatus for the optical disc in the embodiment of the present invention. FIG. 4 is a flowchart showing the operation principle of the information reproducing apparatus for the optical disc in the embodiment of the present invention. FIG. 5 are tables (FIG. 5(a) and FIG. 5(b)) regarding first judgment and second judgment in the operation principle of the information reproducing apparatus for the optical disc in the embodiment of the present invention. FIG. 6 is a graph showing a relationship between a focus error signal and a travel time of an objective lens, the focus error signal being obtained by the irradiation of laser light by the information reproducing apparatus for the optical disc in the embodiment of the present invention, the objective lens travel time being based on a time at which surface reflection is detected. Incidentally, it is to be understood that the travel distance can be uniquely derived from the travel time because the objective lens is displaced at a constant speed.

As shown in FIG. 4, firstly, an optical disc is inserted, for example by a user (step S101).

Then, under the control of the CPU 600, a semiconductor laser (i.e., laser diode) for irradiating the laser light LB1, i.e. a semiconductor laser for BD (Blu-ray Disc), is driven (step S102).

Then, under the control of the CPU 600, the laser light LB 1, such as a blue-ray, is irradiated, and it is judged whether or not there is the first recording layer 101 for BD or the like (step S103). That is, first judgment of the present invention, shown in FIG. 5(a), is performed. More specifically, as shown in FIG. 6, under the control of the CPU 600, the objective lens (or focus lens) is allowed to approach progressively (or continuously). Then, it may be judged that there is the first recording layer 101 if an S-shaped signal in the first recording layer is detected at a distance of “0.1 mm” from the position at which a small S-shaped signal is detected, wherein the small S-shaped signal (in other words, a focus error signal with a S-shaped waveform) indicates surface reflection generated on the incident plane of the polycarbonate layer 104a. Incidentally, a result of the first judgment may be stored into the memory under the control of the CPU 600.

In general, focus lead-in with respect to the information recorded in each recording layer of the multilayer type optical disc is realized by the control of focus servo. More specifically, in the case that the objective lens in the optical pickup is displaced in a direction to approach the optical disc, if the focus (or focal point) is on one recording layer, for example, the focus error signal of reflected light from the semi-transmissive reflective film in the one recording layer converges to “0”. Moreover, in the case that the objective lens is raised and displaced in the direction to approach the optical disc, if the focus is on another recording layer, the focus error signal of reflected light from the semi-transmissive reflective film in the another recording layer converges to “0”. As described above, in the case that the objective lens is displaced in the direction to approach the optical disc, at least two S-shaped signals are obtained, centered on the position of the objective lens when the focus is on the one recording layer (i.e. a “focused focal point” in one recording layer) and a focused focal point in another recording layer. By vertically displacing the position of the objective lens under the control of focus servo which uses the at least two S-shaped signals, it is possible to focus on each of the one recording layer and the another recording layer.

As a result of the judgment in the aforementioned step S103, if it is judged that there is the first recording layer 101 for BD or the like (the step S103: Yes), it is further judged whether or not the first recording layer for BD (Blu-ray Disc) or the like is set by a user as a preferential reproduction layer, in which reproduction is preferentially performed, and it has a high priority for reproduction order, under the control of the CPU 600 (step S104). That is, second judgment of the present invention, shown in FIG. 5(b), is performed. Incidentally, the setting as the preferential reproduction layer by the user, which is a result of the second judgment, may be stored into the memory under the control of the CPU 600. Here, if the first recording layer for BD (Blu-ray Disc) or the like is not set as the preferential reproduction layer and does not have the high priority and if the third recording layer for CD or the like is set as the preferential reproduction layer and has the high priority (the step S104: NO), a semiconductor laser for irradiating the laser light LB3, i.e. a semiconductor laser for CD, is driven under the control of the CPU 600 (step S105).

Then, under the control of the CPU 600, the laser light LB3, such as infrared light, is irradiated, to thereby search for the S-shaped signal corresponding to the recording layer except the first recording layer 101, such as the third recording layer 103 for CD or the like and the second recording layer 102 for DVD or the like (step S106).

Then, under the control of the CPU 600, it is judged whether or not there is the recording layer except the first recording layer 101, such as the third recording layer 103 for CD or the like and the second recording layer 102 for DVD or the like (step S107). If it is judged that there is the recording layer except the first recording layer 101, such as the third recording layer 103 for CD or the like and the second recording layer 102 for DVD or the like (the step S107: Yes), it is judged, substantially as in the aforementioned step S103, whether there is the third recording layer 103 or the second recording layer 102, on the basis of the position at which the S-shaped signal is detected (step S108).

Then, under the control of the CPU 600, it is judged whether or not there is the third recording layer 103 for CD or the like (step S109). More specifically, as shown in FIG. 6 described above, the objective lens is allowed to approach progressively (or continuously), under the control of the CPU 600. Then, it may be judged that there is the third recording layer 103 if the S-shaped signal in the third recording layer is detected at a distance of “1.2 mm” from the position at which the small S-shaped signal is detected, wherein the small S-shaped signal indicates the surface reflection generated on the incident plane of the polyearbonate layer 104a. Alternatively, it may be judged that there is the second recording layer 102 if the S-shaped signal in the second recording layer is detected at a distance of “0.6 mm” from the position at which the small S-shaped signal is detected, wherein the small S-shaped signal indicates the surface reflection generated on the incident plane of the polycarbonate layer 104a.

As a result of the judgment in the aforementioned step S109, if it is judged that there is the third recording layer 103 for CD or the like, namely, if it is judged to be the hybrid type information recording medium provided with the first recording layer for BD or the like and the third recording layer for CD or the like (the step S109: Yes), it is further judged whether or not the third recording layer 103 for CD is set by the user as the preferential reproduction layer, in which the reproduction is preferentially performed, and has a high priority for reproduction order, under the control of the CPU 600 (step S110). If the third recording layer 103 for CD is set by the user as the preferential reproduction layer, in which the reproduction is preferentially performed, and has the high priority for reproduction order (the step S110: Yes), a reproduction setting process is performed under the control of the CPU 600, wherein the reproduction setting process includes the setting of various physical and logical parameters for reproducing the record information recorded in the third recording layer for CD or the like (step S111).

On the other hand, as a result of the judgment in the step S109, if it is judged that there is no third recording layer 103 for CD or the like and that there is the second recording layer 102 for DVD or the like, namely, if it is judged to be the hybrid type information recording medium provided with the first recording layer for BD or the like and the second recording layer for DVD or the like (the step S109: No), it is further judged whether or not the second recording layer 102 for DVD is set by the user as the preferential reproduction layer, in which the reproduction is preferentially performed, and has a high priority for reproduction order, under the control of the CPU 600 (step S112). If the second recording layer 102 for DVD is set by the user as the preferential reproduction layer, in which the reproduction is preferentially performed, and has the high priority for reproduction order (the step S112: Yes), a reproduction setting process is performed under the control of the CPU 600, wherein the reproduction setting process includes the setting of various physical and logical parameters for reproducing the record information recorded in the second recording layer for DVD or the like (step S113). Incidentally, the reproduction setting includes driving the semiconductor laser (or laser diode) corresponding to the laser light LB2.

Moreover, on the other hand, the following process may be performed (i) if, as a result of the judgment in the step S104, the first recording layer for BD (Blu-ray Disc) or the like is set as the preferential reproduction layer and has the high priority (the step S104: Yes), and (ii) if, as a result of the judgment in the step S107, it is judged that there is no recording layer except the first recording layer, such as the third recording layer 103 for CD or the like and the second recording layer 102 for DVD or the like, namely if it is judged to be the information recording medium provided only with the first recording layer for BD or the like (the step S107: No), (iii) if, as a result of the judgment in the step S110, the third recording layer for CD or the like is not set by the user as the preferential reproduction layer in which the reproduction is preferentially performed, and does not have the high priority for reproduction order (the step S110: No), or (iv) if, as a result of the judgment in the step S112, the second recording layer for DVD or the like is not set by the user as the preferential reproduction layer in which the reproduction is preferentially performed, and does not have the high priority for reproduction order (the step S112: No).

That is, under the control of the CPU 600, the laser light LB1, such as a blue-ray, is irradiated, and it is judged whether or not there is the first recording layer 101 for BD or the like (step S114). Here, if there the first recording layer 101 for BD or the like (the step S114: Yes), a reproduction setting process is performed under the control of the CPU 600, wherein the reproduction setting process includes the setting of various physical and logical parameters for reproducing the record information recorded in the first recording layer for BD or the like (step S115) On the other hand, if there is no first recording layer for BD or the like (the step S114: No), a series of reproduction setting process is ended (step S116).

Moreover, on the other hand, as a result of the judgment in the aforementioned step S103, if it is judged there is no first recording layer for BD or the like (the step S103: No), as described above, the judgment process of judging whether there is the third recording layer 103 or the second recording layer 102 is performed on the basis of the position at which the S-shaped signal is detected (the step S108).

(3) Study of Operation and Effect of Information Reproducing Apparatus in Embodiment

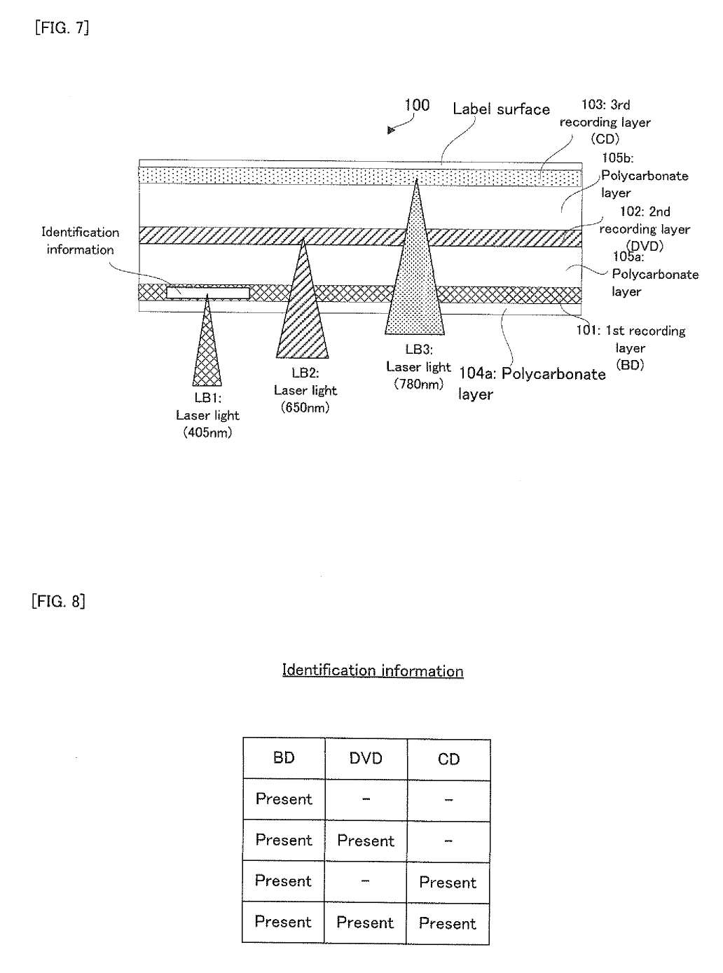

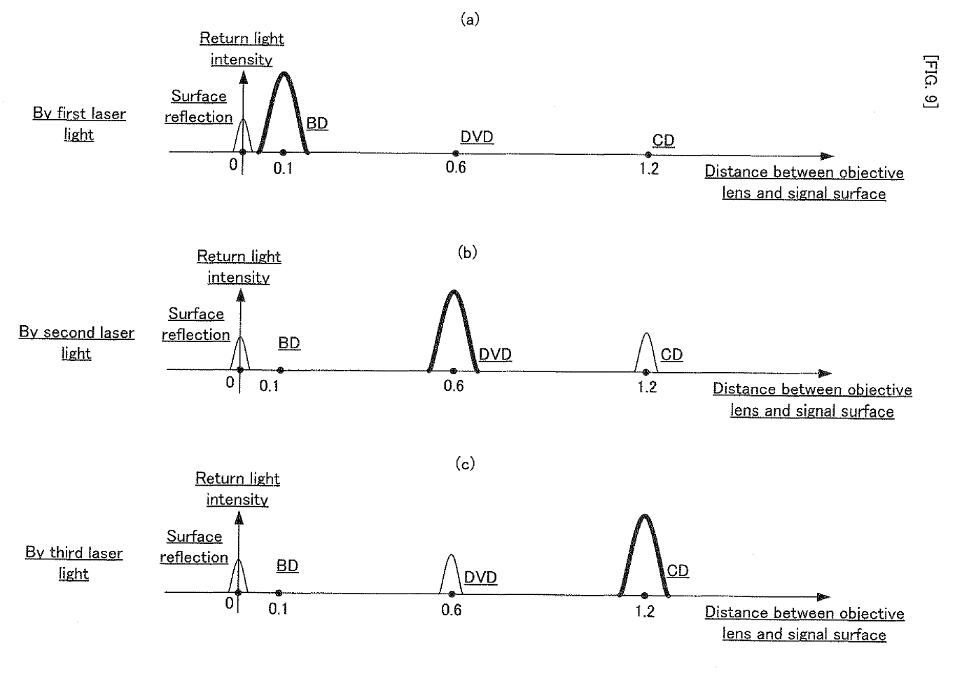

Next, with reference to FIG. 7 and FIG. 8, the operation and effect of the information reproducing apparatus in the embodiment will be considered. FIG. 7 is a detailed cross sectional view showing an optical disc, which is one specific example of the information recording medium in a comparison example. FIG. 8 is a table showing one specific example of identification information in the comparison example.

In a reproducing method for a hybrid disc in the comparison example, it is firstly identified whether or not the information recording medium is the hybrid type information recording medium. Specifically, the reproduction setting is performed, including the setting of various physical and logical parameters for reproducing the record information recorded in the first recording layer corresponding to the first laser light by using the first laser light, such as a blue-ray.

Then, as shown in FIG. 7, the first recording layer is irradiated with the first laser light, to thereby read identification information (i.e. the disc type of the hybrid disc) which can be read by the first laser light. On the basis of the read identification information, it is judged whether or not the information recording medium is the hybrid type information recording medium. More specifically, the identification information includes various information which allows the specification of the types of the recording layers constituting the hybrid disc, as shown in FIG. 8. Incidentally, the identification information is generally recorded into a management area, such as a BCA (Burst Cutting Area), and disc information area.

Then, if the preferential reproduction layer set to preferentially perform the reproduction desired by the user is not the first recording layer, the reproduction setting is performed, including (i) the irradiation of another laser light corresponding to the preferential reproduction layer and (ii) the setting of various physical and logical parameters for reproducing the record information recorded in the preferential reproduction layer.

As described above, the reproducing method for the hybrid type information recording medium in the comparison example needs the reproduction setting redundantly twice if the first recording layer in which the identification information is recorded is not the preferential reproduction layer in which it is set by the user to preferentially perform the reproduction; namely, the reproduction setting including the setting of various physical and logical parameters in the laser light corresponding to the first recording layer and the reproduction setting including the setting of various physical and logical parameters in the laser light corresponding to the preferential reproduction layer. In addition, it is also necessary to perform a process of reading the identification information recorded in the first recording layer. Thus, as described above, it is hard to realize a reduction in time required to start the reproduction of the record information recorded in the preferential reproduction layer desired by the user, only by the amount of time required for the redundant processes, which are (i) the process of the reproduction setting to irradiate the first laser light and (ii) the process of reading the identification information by using the first laser light.

In contrast, according to the embodiment, as described above, the record information recorded on the hybrid type information recording medium is reproduced in the following process. Firstly, it is judged whether or not there is the first recording layer, on the basis of the irradiation of the first laser, such as a blue-ray, under the control of the CPU 600. Specifically, irradiation setting is performed, which includes the setting of various physical parameters for irradiating the first laser light and which is simpler than the aforementioned reproduction setting. Then, by irradiating the first recording layer with the first laser light, it is judged whether or not there is the first recording layer. Here, it is judged that there is the first recording layer, the information recording medium is highly likely the hybrid type information recording medium provided at least with the first recording layer.

Then, if the preferential reproduction layer set to preferentially perform the reproduction desired by the user is the first recording layer, the irradiation setting is omitted because the irradiation setting, including the setting of various physical parameters for irradiating the first laser light, is already completed, and the reproduction of the record information, recorded in the first recording layer, can be quickly started by using the first laser light. On the other hand, if the preferential reproduction layer is not the first recording layer, the reproduction setting is performed, including the setting of various physical and logical parameters for reproducing the record information recorded in the preferential reproduction layer.

As described above, in the reproduction process for the hybrid type information recording medium in the present invention, it is firstly judged whether or not there is the first recording layer corresponding to a Blu-ray, which is a reference recording layer of the hybrid disc. In other words, in the present invention, focus-in (i.e., operation at a focused focal point) is performed, and the first laser light is irradiated with omitting the reproduction setting including the setting of various physical and logical parameters for reproducing the record information recorded in the first recording layer. By this, which it is possible to judge whether or not to be the hybrid type information recording medium.

As a result, for example, even if the first recording layer, which is the essential (or reference) recording layer of the hybrid disc, is not the preferential reproduction layer set to preferentially perform the reproduction by the user, it is only necessary to perform the reproduction setting including the setting of various physical and logical parameters in the laser light corresponding to the preferential reproduction layer, only once without redundancy. In other words, it is possible to omit the reproduction setting including the setting of various physical and logical parameters in the laser light corresponding to the first reproduction layer, and it is also possible to omit the process of reading the identification information recorded in the first recording layer.

Consequently, in the reproducing process for the hybrid type information recording medium, it is possible to realize a reduction in the time required to start the reproduction of the record information recorded in the reproduction layer desired by the user, in all the cases, including the case that the first recording layer is not the preferential reproduction layer.

(4) Another Specific Example of First Judgment in Embodiment

Next, with reference to FIG. 9, another specific example of the first judgment in the embodiment will be explained. FIG. 9 are graphs showing a relationship between a return light intensity and a travel time of an objective lens, the return light intensity being obtained by the irradiation of the laser light by the information reproducing apparatus for the optical disc in the embodiment of the present invention, the objective lens travel time being based on a time at which the return light intensity based on the surface reflection is detected. Incidentally, as described above, it is to be understood that the travel distance can be uniquely derived from the travel time because the objective lens is displaced at a constant speed.

As shown in FIG. 9, another specific example of the first judgment in the embodiment may be performed as follows. Firstly, under the control of the CPU 600, the objective lens is allowed to approach progressively. Then, it may be judged that there is the first recording layer 101 if a chevron-shaped signal that indicates an increase in the return light intensity in the first recording layer is detected at a distance of “0.1 mm” from the position at which a chevron-shaped signal that indicates an increase in the return light intensity based on the surface reflection generated on the incident plane of the polycarbonate layer 104a is detected. Substantially in the same manner, it may be judged that there is the second recording layer 102 if a chevron-shaped signal that indicates an increase in the return light intensity in the second recording layer is detected at a distance of “0.6 mm” from the position at which the chevron-shaped signal that indicates the increase in the return light intensity based on the surface reflection is detected. Moreover, substantially in the same manner, it may be judged that there is the third recording layer 103 if a chevron-shaped signal that indicates an increase in the return light intensity in the third recording layer is detected at a distance of “1.2 mm” from the position at which the chevron-shaped signal that indicates the increase in the return light intensity based on the surface reflection is detected.

(5) Other Specific Example of Information Recording Medium Targeted by Information Reproducing Apparatus in Embodiment

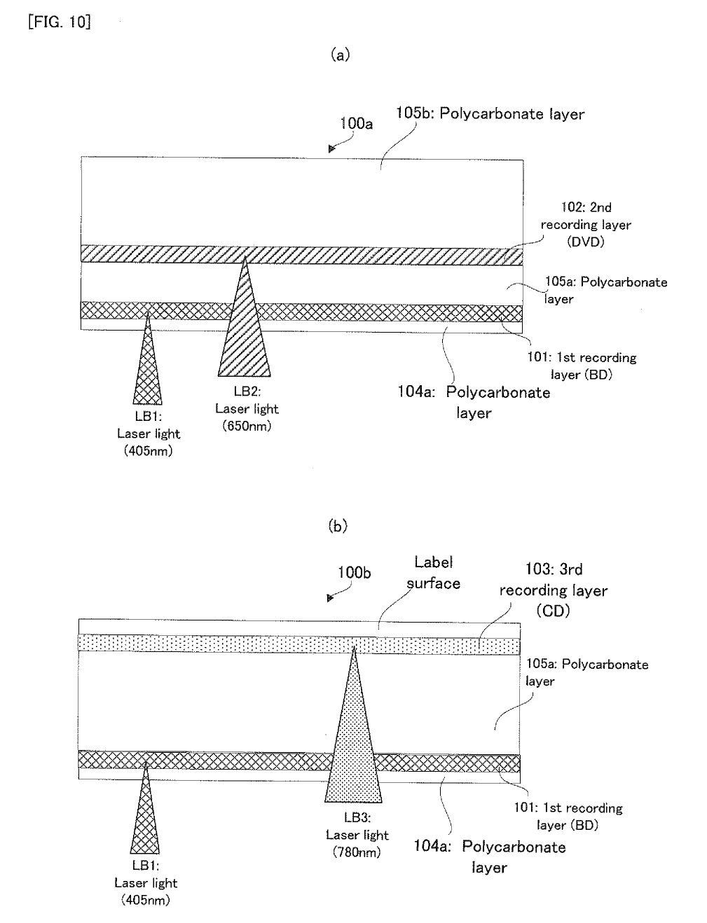

Next, with reference to FIG. 10, a brief explanation will be given on the basic structure of an optical disc, which is another specific example of the information recording medium targeted by the information reproducing apparatus in the embodiment. FIG. 10 are schematic conceptual views (FIG. 10(a) and FIG. 10(b)) showing optical discs 100a and 100b, which are other specific examples of the information recording medium in the embodiment. Incidentally, the same structure as that of the information recording medium in the embodiment described above carries the same numerical reference, and the explanation thereof will be omitted.

As shown in FIG. 10(a), an optical disc 100a, which is another specific example of the information recording medium in the embodiment, may be a dual-layer type information recording medium provided with two recording layers in which reproduction can be performed by using the respective two types of laser light, i.e. the laser light LB1, such as a blue-ray, and the laser light LB2, such as red-light laser light.

Alternatively, as shown in FIG. 10(b), an optical disc 100b, which is another specific example of the information recording medium in the embodiment, may be a dual-layer type information recording medium provided with two recording layers in which reproduction can be performed by using the respective two types of laser light, i.e. the laser light LB1, such as a blue-ray, and the laser light LB3, such as infrared light.

Moreover, in the aforementioned embodiment, an explanation is given on the optical disc 100 as one example of the information recording medium and the player related to the optical disc as one example of the information reproducing apparatus; however, the present invention is not limited to the optical disc and the player for the optical disc, and it can be also applied to other various information recording media which support high-density recording or high transmission rate, and players for the various information recording media.

The present invention is not limited to the aforementioned embodiment, but various changes may be made, if desired, without departing from the essence or spirit of the invention which can be read from the claims and the entire specification. An information reproducing apparatus and method, and a computer program for reproduction control, all of which involve such changes, are also intended to be within the technical scope of the present invention.

### INDUSTRIAL APPLICABILITY

The information reproducing apparatus and method, and the computer program according to the present invention can be applied to an information reproducing apparatus for performing reproduction on a multilayer hybrid type information recording medium, such as a dual-layer hybrid type optical disc. Moreover, they can be applied to a recording apparatus or the like which is mounted on various computer equipment for consumer use or for commercial use, or which can be connected to various computer equipment.

1. An information reproducing apparatus for performing reproduction on an information recording medium provided with at least one recording layer of (ii-1) a second recording layer with a signal surface on which reading can be performed by second laser light with a second wavelength and (ii-2) a third recording layer with a signal surface on which reading can be performed by third laser light with a third wavelength, in addition to (i) a first recording layer with a signal surface on which reading can be performed by first laser light with a first wavelength, said information reproducing apparatus comprising:
an optical pickup device for irradiating the first laser light, the second laser light, or the third laser light and receiving reflected light thereof,
a first judging device for performing first judgment on whether or not there is the first recording layer, on the basis of an output of said optical pickup device;
a second judging device for performing second judgment on whether or not one of the first recording layer, the second recording layer, and the third recording layer is set by a user as a preferential reproduction layer in which the reproduction is preferentially performed;
a reproducing device for reproducing record information recorded in the first recording layer, the second recording layer, or the third recording layer; and
a controlling device for controlling said reproducing device to reproduce the record information on the basis of the first judgment, the second judgment, and the output of said optical pickup device.

2. The information reproducing apparatus according to claim 1, wherein the first laser light is laser light in substantially blue to substantially bluish-purple, the second laser light is laser light in substantially red, and the third laser light is infrared light.

3. The information reproducing apparatus according to claim 1, wherein the first recording layer is disposed on the closest side, viewed from a laser light irradiation side.

4. The information reproducing apparatus according to claim 1, wherein the first recording layer, the second recording layer, and the third recording layer are disposed in order of the first recording layer, the second recording layer, and the third recording layer, from a laser light irradiation side.

5. The information reproducing apparatus according to claim 1, wherein said first judging device further performs third judgment on whether or not there is the second recording layer or the third recording layer, on the basis of the output of said optical pickup device.

6. The information reproducing apparatus according to claim 1, wherein said first judging device performs the first judgment on the basis of the output of said optical pickup device, the output being performed by receiving the reflected light of the irradiated first laser light.

7. The information reproducing apparatus according to claim 1, wherein
the information recording medium comprises a first management area in which identification information can be recorded, the identification information identifying whether or not the information recording medium is a hybrid disc provided with at least one of the second recording layer and the third recording layer, in addition to the first recording layer and
said first judging device performs the first judgment without reading the identification information.

8. The information reproducing apparatus according to claim 1, wherein
the first recording layer comprises a second management area in which the identification information can be recorded, and
said first judging device performs the first judgment without reading the identification information.

9. The information reproducing apparatus according to claim 1, wherein said first judging device performs the first judgment on the basis of whether or not an S-shaped signal, which indicates a focused focal point in the first recording layer, can be detected at a predetermined depth.

10. The information reproducing apparatus according to claim 1, wherein said first judging device performs the first judgment on the basis of whether or not return light with a predetermined light intensity, caused by the irradiation of the first laser light, can be obtained at a predetermined depth.

11. The information reproducing apparatus according to claim 1, wherein said controlling device further controls said reproducing device to perform reproduction setting for reproducing record information recorded in each of the first recording layer, the second recording layer, and the third recording layer.

12. An information reproducing method in an information reproducing apparatus comprising: an optical pickup device for irradiating an information recording medium with a first laser light, a second laser light, or a third laser light and receiving reflected light thereof; and a reproducing device for reproducing record information recorded in the first recording layer, the second recording layer, or the third recording layer, the information recording medium provided with at least one recording layer of (ii-1) the second recording layer with a signal surface on which reading can be performed by second laser light with a second wavelength and (ii-2) the third recording layer with a signal surface on which reading can be performed by third laser light with a third wavelength, in addition to (i) the first recording layer with a signal surface on which reading can be performed by first laser light with a first wavelength, said information reproducing method comprising:
a first judging process of performing first judgment on whether or not there is the first recording layer, on the basis of an output of said optical pickup device;
a second judging process of performing second judgment on whether or not one of the first recording layer, the second recording layer, and the third recording layer is set by a user as a preferential reproduction layer in which the reproduction is preferentially performed; and
a controlling process of controlling said reproducing device to reproduce the record information on the basis of the first judgment, the second judgment, and the output of said optical pickup device.

13. A computer program for reproduction control and for controlling a computer provided in the information reproducing apparatus according to claim 1, said computer program making the computer function as at least one portion of said optical pickup device, said first judging device, said second judging device, said reproducing device, and said controlling device.
